(19) United States
(12) Patent Application Publication
(10) Pub. No.: US 2005/0051400 A1
(43) Pub. Date: Mar. 10, 2005

(54) Pedal assembly retracting in a front vehicular impact

(75) Inventors: Jean-Michel Humbert, Neuilly Sur Seine (FR); Laurent Chan-Ng-Yok, Puteaux (FR); Silvio Endrizzi, Den Haag (NL); Chris Jagger, Wakefield (GB)

Correspondence Address: LEYDIG VOIT & MAYER, LTD, 700 THIRTEENTH ST. NW, SUITE 300, WASHINGTON, DC, 20005-3960, US

(73) Assignee: BCK TECHNOLOGY LTD, Scunthorpe (GB)

(21) Appl. No.: 10/839,721

(22) Filed: May 6, 2004

(30) Foreign Application Priority Data
May 9, 2003 (FR) 03 05 627

(51) Int. Cl. F16F 7/12

(52) U.S. Cl. 188/371

(57) ABSTRACT

A pedal assembly support is articulated on a shaft connected to the dashboard of a vehicle. The pedal assembly support is attached to the dashboard by projections capable of deformation, and two ramp pieces connected to the dashboard, each piece having a ramp facing an upper end of a control lever of a clutch pedal and an upper end of a control lever of a brake pedal. The control levers are further connected to their respective clutch and brake components by rocker bars pivoting on a common shaft supported by the two ramp pieces. In a front impact, the projections collapse against the dashboard, and the pedal assembly support pivots about the shaft leading the ends of the control levers to rest on the ramps of the ramp pieces, swinging the control levers towards the bottom wall of the footwell.

The present invention pertains to the field of automobile driver safety in case of front impact to an automobile.

With an ordinary type pedal assembly, the brake pedal and the clutch pedal are mounted in a pedal assembly support attached in a non-deformable way to the dashboard. In case of front impact, the structure of the vehicle, and therefore the dashboard supporting the pedal assembly, deform and simultaneously lead to a backward movement and raising of the pedal assembly into the legs of the driver, which can cause lesions to the lower limbs, possibly to the point of fracture.

The device according to the invention is provided in order to limit the backward movement and raising of the pedal assembly in case of front impact, thus improving driver protection.

Thus, the present invention generally pertains to a pedal assembly device, which is retractable in case of front impact to a vehicle, which has a pedal assembly support mounted on the dashboard of the vehicle in the footwell of the vehicle, and articulated on which are, on the one hand, a control lever of the brake pedal, and on the other hand, a control lever of the clutch pedal.

In order to solve the aforementioned problem, the device is characterized by the fact that the pedal assembly support is articulated on a horizontal rotary shaft perpendicular to the longitudinal axis of the vehicle and which is supported by plates connected to the dashboard, where this pedal assembly support is attached to a piece connected to the vehicle by projections capable of deformation according to the direction of a front impact, and by the fact that two pieces connected to the dashboard are provided, each having a ramp facing the upper end of each control lever extending beyond its shaft of articulation to the pedal assembly support, so that in the absence of a front impact, action on the pedal of the corresponding control lever leads said control lever to act on the brake or clutch, and in case of a front impact to the vehicle, the pedal assembly support pivots towards the dashboard about the horizontal rotary shaft deforming the projections by collapsing, so that the upper ends of the brake and clutch control levers come to rest on the respective ramps of the two ramp pieces causing the swinging of the control levers towards the bottom wall of the footwell.

According to other advantageous characteristics of the invention:
the piece connected to the vehicle is the dashboard, and in case of front impact to the vehicle, the pedal assembly support runs into an impact piece connected to the structure of the vehicle, causing the projections to deform and thus inducing the pivoting of the pedal assembly support;
the impact piece connected to the structure of the vehicle is an element which is rigidly connected to the crosspiece of the instrument panel of the vehicle, such as a column support intended for maintaining the steering column with respect to said crosspiece;
the piece connected to the vehicle is a piece whose deformation in case of impact is less than that of the dashboard, and in case of a front impact to the vehicle, the relative deformation of the dashboard with respect to this piece causes the projections to deform and thus induces the pivoting of the pedal assembly support;
the piece whose deformation in case of impact is less than that of the dashboard is the lower crosspiece of the opening;
the brake and clutch control levers act on their respective brake and clutch components by means of control rocker bars mounted to pivot on a common shaft which is transverse to the longitudinal axis of the vehicle and supported by the two ramp pieces, and by the fact that in case of front impact to the vehicle, the connection between the ends of the control levers and their respective rocker bars is released so that the brake and clutch pedals become slack;
the pedal assembly support is in the form of a yoke, the two lateral branches of which are articulated to the aforementioned horizontal rotary shaft, and the horizontal arm connecting the two lateral branches is arranged facing the impact piece a predetermined distance from it in normal conditions of use.

The invention will be better understood and other aims, characteristics, details and advantages thereof will appear more clearly in the course of the following explanatory description with reference to the appended drawings given only by way of example, illustrating an embodiment of the invention and in which:

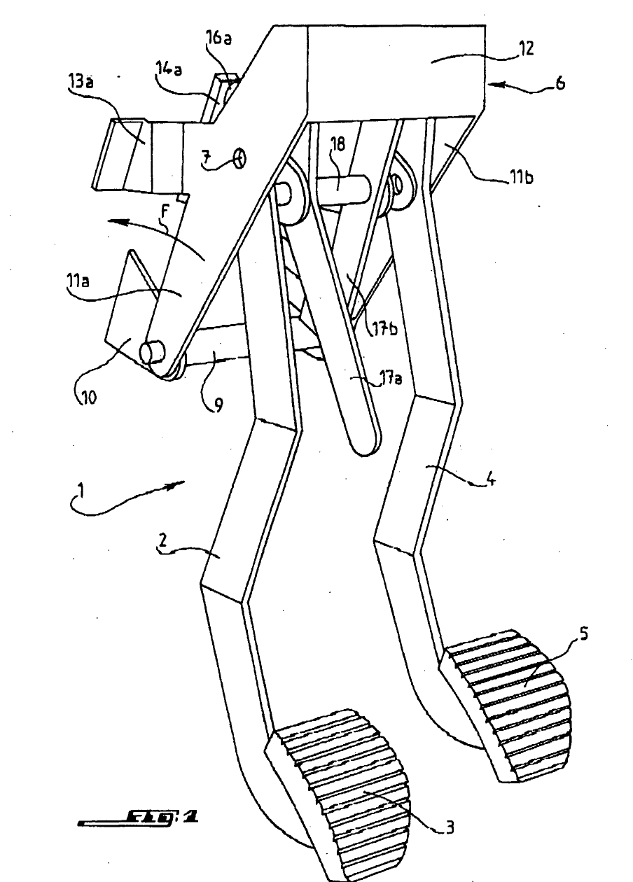

FIG. 1 is a perspective view of the pedal assembly device according to the invention and in particular shows the control levers of the brake and clutch pedals mounted in a known manner on the dashboard of a vehicle in its footwell;

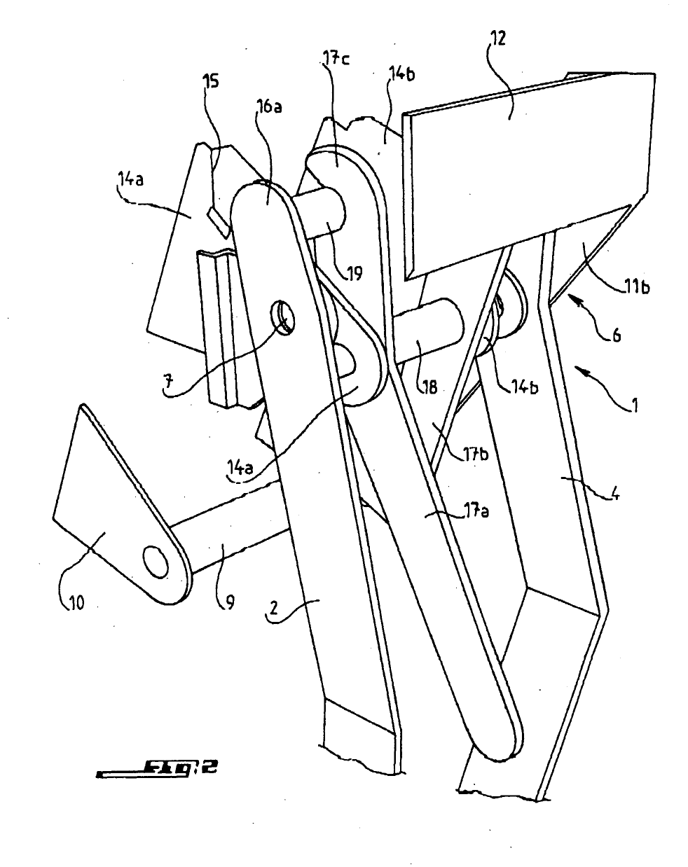

FIG. 2 is a view in enlarged scale of a detail of FIG. 1 and in particular shows ramp pieces connected to the dashboard and with which the upper ends of the brake and clutch pedal control levers cooperate in order to make these levers swing towards the bottom wall of the footwell in case of front impact;

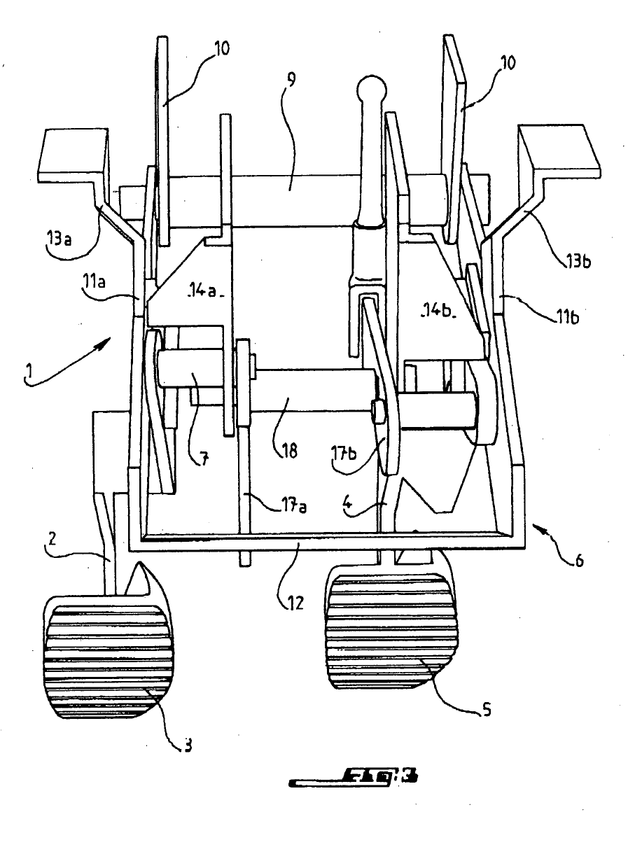

FIG. 3 is a top view of the device of the preceding figures;

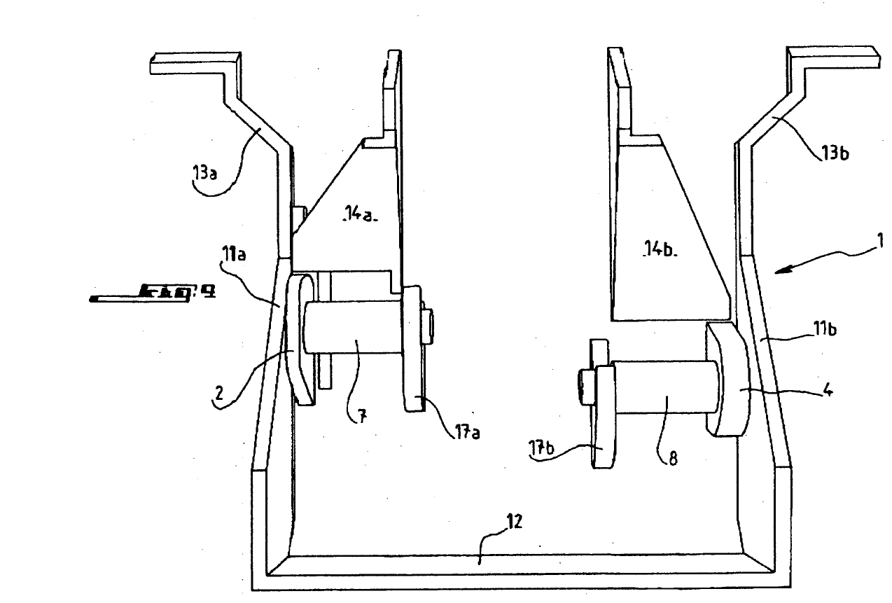

FIG. 4 is a partial top view similar to FIG. 3 of the device according to the invention.

In the drawings, the pedal assembly device according to the invention which is retractable in case of front impact to a vehicle is referenced overall by 1. Like any pedal assembly device, retractable pedal assembly device 1 according to the invention is mounted on the dashboard of the vehicle in its footwell, and comprises, on the one hand, control lever 2 of clutch pedal 3, and on the other hand, control lever 4 of brake pedal 5.

Control lever 2 of the clutch and control lever 4 of the brake are in this case mounted on pedal assembly support 6, and are articulated thereto by means of articulation pins 7 and 8, respectively. Furthermore, pedal assembly support 6 is itself mounted on the dashboard of the vehicle by being articulated to horizontal rotary shaft 9 perpendicular to the longitudinal axis of the vehicle and whose ends are supported by plates 10 connected to the dashboard.

As seen in the drawings, pedal assembly support 6 is in the form of a yoke and has two lateral branches 11a, 11b articulated at their lower ends on horizontal rotary shaft 9 and connected at their upper ends by connecting arm 12.

According to the invention, pedal assembly support 6, thus articulated at 9, is attached to the dashboard by projections 13a, 13b provided so as to be capable of deforming according to the direction of a front impact to the vehicle.

Furthermore, two pieces 14a, 14b, each having ramp 15 and which can be seen clearly in FIGS. 2 to 4, are mounted on the dashboard in such a way that in the normal state of operation of the device, that is, before front impact, ramps 15 are facing upper end 16a and respectively 16b of clutch control lever 2 and brake control lever 4.

In order to control their clutch and brake components, clutch control lever 2 and brake control lever 4 are both provided with a system of rocker bars 17a and 17b connected to the respective clutch and brake components by an appropriate rod assembly. Rocker bars 17a and 17b are mounted to pivot on common articulation shaft 18 which is transverse to the longitudinal axis of the vehicle and supported by the two ramp pieces 14a and 14b. As seen in the drawings, and more specifically in FIG. 2, upper free ends 17c of rocker bars 17a and 17b are in the form of hooks and are caught on rod 19 connected to upper ends 16a, 16b of control levers 2, 4, which ensures the connection of the control levers and their respective rocker bars and therefore of the control levers and the corresponding clutch and brake components.

The aforementioned device functions in the manner indicated below.

In the absence of front impact to the vehicle, the driver's actions on the clutch or brake pedal affect the clutch or brake components in the conventional manner by means of the corresponding control lever and rocker bar system.

On the other hand, at the moment of impact to the vehicle, horizontal arm 12 of pedal assembly support 6 runs into an impact piece connected to the structure of the vehicle and placed facing this arm a predetermined distance from it in the normal position of use, that is, to before impact. The impact piece is an element which is rigidly connected to the crosspiece of the instrument panel of the vehicle, such as a column support intended for maintaining the steering column with respect to said crosspiece.

It is understood then that in the presence of front impact to the vehicle, the impact piece above undergoes a deformation or backward movement which is almost zero or relatively slight in comparison with the deformation or backward movement undergone by the dashboard. Thus, the backward movement of the dashboard in the case of front impact leads at the same time to the backward movement of the pedal assembly with the disadvantages mentioned in the preceding in the absence of the pedal assembly device according to the invention which is retractable in case of front impact.

In the device according to this first embodiment of the invention, pedal assembly support 6 runs into the impact piece by its horizontal arm 12. In a second embodiment, projections 13a and 13b are attached to a piece, for example, the lower crosspiece of the opening, whose deformation in case of impact is less than that of the dashboard on which the two ramp pieces 14a and 14b are attached. At the moment of impact to the vehicle, the relative deformation of the dashboard with respect to this piece causes projections 13a and 13b to deform and thus induces the pivoting of pedal assembly support 6. In comparison with the first embodiment, there is no longer any need for the impact piece in order to bring about the deformation.

In the two embodiments, and in accordance with the foregoing, pedal assembly support 6 then pivots about horizontal rotary shaft 9 in the direction of the dashboard according to arrow F, and this movement deforms projections 13a, 13b by collapsing. Control levers 2, 4 then tend to rise so that their upper ends come to rest on respective ramps 15 of the two ramp pieces 14a, 14b so as to bring about the swinging of the control levers towards the bottom wall of the footwell. At the same time that this movement takes place, upper ends 17c of rocker bars 17a, 17b disengage from rod 19 so that the connection between the control levers and their respective rocker bars is released, and clutch pedal 3 and brake pedal 5 become slack.

The invention is however not limited to the embodiment example represented and described in detail since various modifications can be contributed to it without leaving the scope of the invention.

1. A pedal assembly device which retracts in case of a front impact to a vehicle including the pedal assembly device, the pedal assembly device comprising:
a pedal assembly support mounted on a dashboard of a vehicle in a footwell of the vehicle, articulation shafts, on which a control lever of a clutch pedal and a control lever of a brake pedal are respectively articulated;
a horizontal rotary shaft, perpendicular to a longitudinal axis of the vehicle, supported by plates connected to the dashboard;
a piece connected to the vehicle by projections, deformable in the direction of a front impact, and attached to the pedal assembly support;
two ramped pieces connected to the dashboard, each ramped piece having a ramp facing an upper end of a respective control lever and extending beyond respective articulation shafts to the pedal assembly support, wherein action on a pedal is transmitted by the corresponding control lever to the respective clutch and the brake, and, in response to a front impact to the vehicle, the pedal assembly support pivots towards the dashboard about the horizontal rotary shaft, and collapses the projections so that upper ends of the clutch control lever and of the brake control lever come to rest on respective ramps of the two ramped pieces, swinging the control levers towards a bottom wall of the footwell.

2. The device according to claim 1, wherein the piece connected to the vehicle is the dashboard, and, in case of a front impact to the vehicle, the pedal assembly support impacts an impact piece connected to the vehicle, causing the projections to deform, inducing pivoting of the pedal assembly support.

3. The device according to claim 2, wherein the impact piece connected to the vehicle is rigidly connected to cross-piece of an instrument panel of the vehicle.

4. The device according to claim 1, wherein the piece connected to the vehicle is deformed, in case of an impact, less than the dashboard, and, in case of a front impact to the vehicle, relative deformation of the dashboard with respect to the piece causes the projections to deform, including pivoting of the pedal assembly support.

5. The device according to claim 4, wherein the piece deforming less than the dashboard consists of a lower cross-piece of an opening.

6. The device according to claim 1, including control rocker bars, wherein the control lever of the clutch and the control lever of the brake act on respective clutch and brake components through the control rocker bars, the control rocker bars pivoting on a common shaft which is transverse to the longitudinal axis of the vehicle and supported by the two ramped pieces, and, in case of a front impact to the vehicle, connections between the control levers and the respective rocker bars are released so that the clutch pedal and the brake pedal become slack.

7. The device according to claim 1, wherein the pedal assembly support includes a yoke, having two lateral branches which are articulated to the horizontal rotary shaft, and including a horizontal arm connecting the two lateral branches, facing and spaced from the impact piece.
